(19) United States
(12) Patent Application Publication
(10) Pub. No.: US 2008/0247745 A1
(43) Pub. Date: Oct. 9, 2008

(54) CAMERA ASSEMBLY WITH ZOOM IMAGING AND METHOD

(76) Inventor: Rene Nilsson, Eslov (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/696,203

(22) Filed: Apr. 4, 2007

(51) Int. Cl. G03B 41/00

(52) U.S. Cl. 396/322

(57) ABSTRACT

A method of imaging a scene with a camera assembly includes imaging a first portion of the scene to generate a first image corresponding to a field of view of the camera assembly when a component of the camera assembly that is in an optical pathway of the camera assembly is in a first position with respect to a housing of the camera assembly. The component is then moved to a second position with respect to the housing to change the field of view of the camera assembly and a second portion of the scene is imaged to generate a second image. The first and second images are stitched together to generate a stitched image that corresponds to a region of the scene that is larger than each of the first portion of the scene and the second portion of the scene.

### TECHNICAL FIELD OF THE INVENTION

The present invention relates generally to photography and, more particularly, to a system and method to image a wide field of view under magnification.

### DESCRIPTION OF THE RELATED ART

The field of view of a camera has a relationship to the amount of zoom selected by the user. In general, as zoom increases, the field of view of the camera decreases. Thus, when zoom in employed, the portion of a scene captured in a corresponding photograph will be smaller than the portion of the same scene captured in a photograph that is taken without zoom or with less zoom. At the same time, the portion of the scene imaged in the photograph taken with zoom will be magnified relative to the corresponding portion of the scene appearing in the photograph taken without zoom or with less zoom. If a digital camera is used with fixed resolution settings, both of these exemplary photographs will be imaged with the same resolution.

When using zoom, at least some of the scene is lost compared to an image of the scene without zoom or with less zoom. Some users may desire an image of more of the scene, but with the magnification provided by the zoom. In this case, the user may take several photographs using the zoom and stitch the resulting images together to construct a zoomed image of a desired portion of the scene. This process may be assisted with software, but remains a manual process that is tedious and difficult to accomplish. Also, the individual photographs are taken one at a time with user movement of the camera between each photograph. As such, there may not be enough overlap among the photographs to seamlessly stitch the photographs together and/or there may be changes in perspective from one photograph to the next.

### SUMMARY

According to one aspect of the disclosure, a method of imaging a scene with a camera assembly includes imaging a first portion of the scene to generate a first image corresponding to a field of view of the camera assembly when a component of the camera assembly that is in an optical pathway of the camera assembly is in a first position with respect to a housing of the camera assembly; moving the component to a second position with respect to the housing to change the field of view of the camera assembly and imaging a second portion of the scene to generate a second image; and stitching the first and second images together to generate a stitched image that corresponds to a region of the scene that is larger than each of the first portion of the scene and the second portion of the scene.

According to one embodiment of the method, during imaging of the first and second portions of the scene, the camera assembly is placed in a zoomed configuration so that each image is a magnified representation of the scene.

According to one embodiment of the method, imaging of the first and second portions of the scene and moving of the component are carried out in response to a single depression of a shutter button by a user of the camera assembly.

According to one embodiment of the method, the first image and the second image contain an overlapping portion of the scene.

According to one embodiment of the method, the camera assembly includes a sensor arranged in a plane transverse to an optical axis of the field of view of the camera assembly; and a reflecting device to redirect light from the scene toward the sensor, the reflecting device being the component that is moved.

According to one embodiment of the method, the reflecting device is a mirror.

According to one embodiment of the method, the reflecting device is a prism.

According to one embodiment of the method, the reflecting device is moved about one or more axes.

According to one embodiment, the method further includes imaging additional portions of the scene and each image corresponding to a different field of the view of the camera assembly that is achieved by movement of the component, and the stitching includes stitching each image together.

According to one embodiment of the method, the images are arranged in one row or one column.

According to one embodiment of the method, the images are arranged in more than one row or more than one column.

According to one embodiment, the method further includes windowing the stitched image and cropping a portion of the stitched image falling outside the window.

According to one embodiment of the method, the camera assembly is part of a mobile telephone.

According to another aspect of the disclosure, a camera assembly includes a sensor arranged in a plane transverse to an optical axis of the field of view of the camera assembly; a reflecting device to redirect light from the scene toward the sensor; and a driver to move the reflecting device between a first imaging of the scene to generate a first image corresponding to a first field of view of the camera assembly when the reflecting device is in a first position and a second imaging of the scene to generate a second image corresponding to a second field of view of the camera assembly when the reflecting device is in a second position.

According to one embodiment, the camera assembly further includes a controller that stitches the first and second images together to generate a stitched image that corresponds to a region of the scene that is larger than each of a first portion of the scene represented in the first image and a second portion of the scene represented in the second image.

According to one embodiment of the camera assembly, the reflecting device is a mirror or a prism.

According to one embodiment of the camera assembly, the reflecting device is moveable about one or more axes.

According to one embodiment of the camera assembly, during imaging of the first and second images, the camera assembly is placed in a zoomed configuration so that each image is a magnified representation of the scene.

According to one embodiment of the camera assembly, imaging of the first and second portions of the scene and moving of the component are carried out in response to a single depression of a shutter button by a user of the camera assembly.

According to one embodiment of the camera assembly, the camera assembly is part of a mobile telephone.

These and further features will be apparent with reference to the following description and attached drawings. In the description and drawings, particular embodiments have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIGS. 1A and 1B are schematic views of a camera assembly respectively configured to image a first portion of a scene and a second portion of the scene for zoom imaging of the scene;

FIGS. 2A and 2B are a schematic front view and a schematic rear view of a mobile telephone that includes a camera assembly adapted for zoom imaging of a scene;

FIG. 3 is a schematic block diagram of portions of the mobile telephone of FIGS. 2A and 2B;

FIG. 4 is a schematic diagram of a communications system in which the mobile telephone of FIGS. 2A and 2B may operate; and

FIGS. 5A, 5B and 5C are a series of progressive illustrations of images of a scene captured by a camera assembly that is adapted for zoom imaging.

### DETAILED DESCRIPTION OF EMBODIMENTS

Embodiments will now be described with reference to the drawings, wherein like reference numerals are used to refer to like elements throughout. It will be understood that the figures are not necessarily to scale.

Aspects of this disclosure relate to photography. The techniques described herein may be applied to taking photographs with a digital camera, such as a digital still camera. The techniques described herein may be modified to be applied to taking video with a digital video camera and such modifications will be apparent to one of ordinary skill in the art. It will be appreciated that some digital cameras are capable of taking both still images and video. The techniques described herein are not limited to digital photography and may be adapted for use in conjunction with a film camera.

The techniques described herein may be carried out by any type of electronic device that includes a suitably configured camera. For instance, a dedicated still and/or video digital camera may be constructed as described herein. As another example, many mobile telephones include cameras that may be constructed in accordance with the present description. By way of example, portions of the following description are made in the context of a mobile telephone that includes a camera assembly. However, it will be appreciated that the invention is not intended to be limited to the context of a mobile telephone and may relate to any type of appropriate electronic equipment, examples of which include a dedicated camera, a media player that includes a camera, a gaming device that includes a camera, a computer that includes a camera and so forth.

For purposes of the description herein, the interchangeable terms “electronic equipment” and “electronic device” include portable radio communication equipment. The term “portable radio communication equipment,” which herein after is referred to as a “mobile radio terminal,” includes all equipment such as mobile telephones, pagers, communicators, electronic organizers, personal digital assistants (PDAs), smartphones, portable communication apparatus or the like.

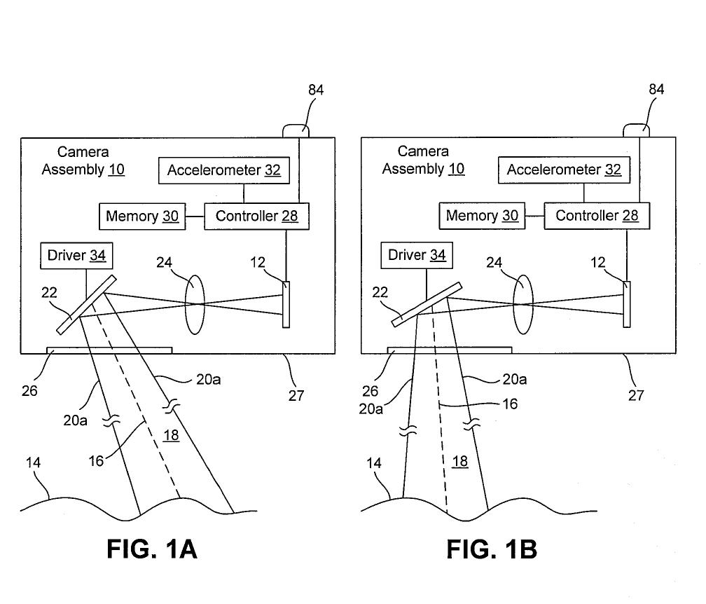

Referring initially to FIGS. 1A and 1B, illustrated is a camera assembly 10. As indicated, the camera 10 assembly may be embodied as a dedicated camera or as part of a device that performs other functions, such as making telephone calls, playing audio and/or video content, and so forth.

In the illustrated embodiment, an optical pathway is arranged in a folded configuration. For instance, a sensor 12 that is used to image a portion of a scene (represented by curvy line 14) is arranged in a plane that is transverse to an optical axis (represented by dashed line 16) of a field of view 18 (bounded by lines 20a and 20b) of the camera assembly 10. A breadth of the field of view 18 may have a relationship to a zoom setting (e.g., 1× zoom for no zoom, 1.5× zoom, 2× zoom, 4× zoom, etc.). In the exemplary embodiment, a reflecting element 22 redirects light from the scene 14 toward the sensor 12. The light may be focused onto the sensor by one or more optical elements 24, such as one or more lenses. The light may enter the camera assembly 10 through a window 26. The window 26 minimizes entry of particles and contaminants into an interior of a camera body (or housing) 27 of the camera assembly, but also may have optical properties to function as a lens and/or a filter. In one embodiment, the sensor 12 may be a charge-coupled device (CCD). In one embodiment, the reflecting element 22 may be a mirror. In another embodiment, the reflecting element 22 may be embodied as a prism, such as a triangular prism where one side is arranged to reflect the light using total internal reflection. A greater degree of chromatic aberration may be experienced with a prism than with a mirror.

The camera assembly 10 may include a controller 28 that controls operation of the camera assembly 10. In one embodiment, the controller 28 may execute logical instructions that carry out the zoom functions described herein. The controller 28 may be implemented as a microcontroller, a general purpose processor for executing logical instructions (e.g., software), a digital signal processor (DSP), a dedicated circuit, or a combination of devices. While the functionality to carry out the zoom functions described herein is preferably implemented in software, such functionality may alternatively be implemented in firmware, dedicated circuitry or a combination of implementing platforms.

The camera assembly 10 may further include a memory 30 that stores software to be executed by the controller 28. As such, the memory 30 may include one or more components, such as a non-volatile memory for long term data storage (e.g., a hard drive, a flash memory, an optical disk, etc.) and a system memory (e.g., random access memory or RAM). The memory 30 may be used to store data files corresponding to images captured with the camera assembly 10. All or a portion of the memory 30 may be embodied as a removable device, such as a memory card.

One or more accelerometers 32 or other motion sensing devices may be present in the camera assembly 10 to provide a signal or signals representative of movement of the camera assembly 10. As will be described below, movement of the camera assembly 10 during the imaging of the scene 14 imaging may be used to assist in constructing a single image from plural images of corresponding portions of the scene 14.

The reflecting element 22 may be positionable under the influence of a driver 34. The driver 34 may include, for example, a motor and associated linking components to couple the motor and the reflecting element 22. In other embodiments, the driver 34 may include micromechanics, microelectromechanical system (MEMS) components, and/or a piezoelectric device (e.g., transducer or vibrator) to effectuate mechanical movement of the reflecting element 22.

FIGS. 1A and 1B respectively show the reflecting device 22 in a first position and a second position. Although only two positions are illustrated, it will be understood that additional positions are possible. Each position corresponds to a different relative field of view 18. As a result, an image captured by the sensor 12 when the reflecting device 22 is in the first position will correspond to a different portion of the scene 14 than an image captured by sensor 12 when the reflecting device 22 is in the second position or an additional position (e.g., third, fourth, fifth and so on positions).

Changes in position of the reflecting device 22 with respect to the camera body 27 may be accomplished by actuation of the driver 14, which may operate under the control of the controller 28. In one embodiment, changes to the position of the reflecting device 22 are achieved by changing the angle of the reflecting device 22 with respect to an optical axis of the optical element(s) 24 and the sensor 12. Changes to the angle of the reflecting device 22 may include pivoting, rotating and/or tilting the reflecting device about one or more axes. Also, the placement or position of the entire reflecting device 22 may be changed. In other embodiments, movement of the reflecting device may include deforming the reflecting device 22.

Thus, if the scene 14 where separately imaged when the reflecting device 22 is in each one of plural positions, each image may correspond to a different portion of the scene 14. In one embodiment, the position of the reflecting device 22 may be controlled so that each image portion of the scene 14 is immediately adjacent (e.g., “touching”) at least one other imaged portion of the scene. To facilitate stitching of adjacent images together, it may be preferable that the position of the reflecting device 22 is controlled so that each image portion of the scene 14 is overlapping with at least one other imaged portion of the scene. For instance, depending on the orientation of the camera assembly 10 at the time of imaging, a first image corresponding to a first position of the reflecting device 22 may be laterally adjacent a second image corresponding to a second position of the reflecting device 22, and the second image may be laterally adjacent a third image corresponding to a third position of the reflecting device 22. Additional positioning of the reflecting device 22 may result in capturing images that are above and/or below these images and that are immediately adjacent or overlapping with at least one of the other images.

Various relative arrangements of images that collectively capture a region of the scene 14 are possible. For example, the images may be arranged in series with one another (e.g., one row or one column of images). In another example, the images may be arranged in a square or a rectangle (e.g., images arranged in two or more rows and two or more columns). In yet another example, the images may be arranged in staggered fashion (e.g., images in one row or column may be offset from images in an adjacent row or column). In the multiple row and/or column embodiments, adjacent rows or columns need not have the same number of images.

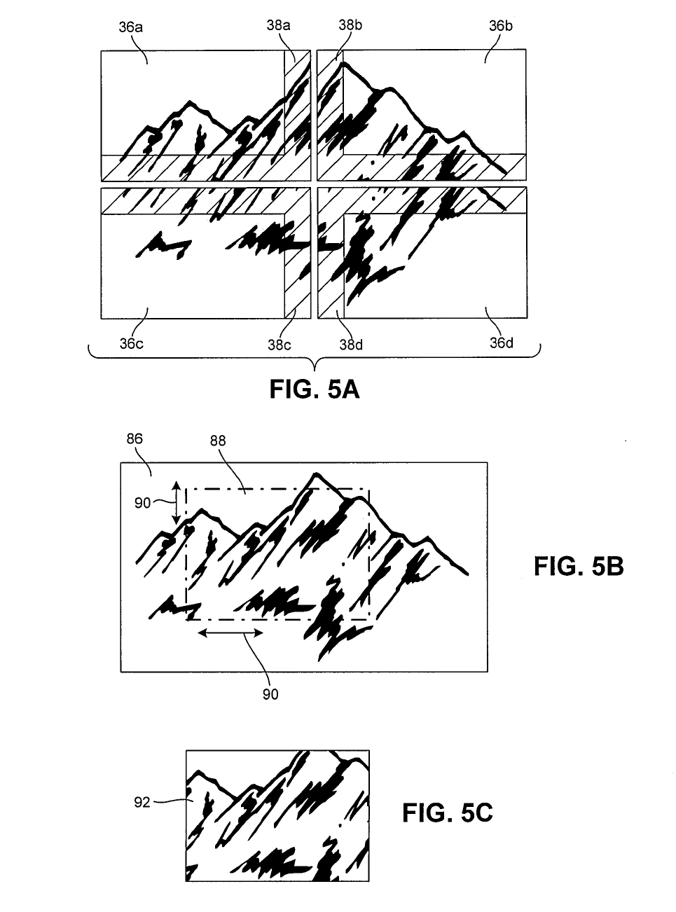

FIG. 5A illustrates one exemplary arrangement of images 36. In the exemplary arrangement, four images 36a through 36d are present. In this example, each image 36 contains a portion of a mountain scene. Also, in this exemplary illustration, each image 36 contains a portion of the scene that is also present in at least one of the other images 36. The portion of the scene present in multiple images 36 may be referred to as an overlapping portion and is represented by cross-hatched areas 38a through 38d. In the exemplary arrangement, image 36a and image 36b laterally overlap each other and form a first row, image 36c and image 36d laterally overlap each other and form a second row, and the two rows vertically overlap each other.

The individual images 36 may be taken in sequence by positioning the reflecting device 22 such that the camera assembly's field of view 18 corresponds to a first portion of the scene 14 desired for the first image 36a and capturing the first image 36a with the sensor 12. Then, the reflecting device 22 may be repositioned such that the camera assembly's field of view 18 corresponds to a second portion of the scene 14 desired for the second image 36b and capturing the second image 36b with the sensor 12. This may be repeated for the remaining images. For each image, a corresponding file may be stored by the memory 30. Alternatively, the data for each image may be stored in one file or temporarily buffered.

With continuing reference to FIGS. 1A and 1B, the illustrated embodiment also shows the camera assembly 10 in a zoomed configuration to magnify the portion of the scene 14 falling within the field of view 18. In this illustrated embodiment that employs the folded camera assembly 10 configuration, zoom is achieved by moving the sensor 12 away from the reflecting element 22 and, if needed, adjusting the position of the optical element(s) 24 to focus the image on the sensor 12. For “normal” imaging of the scene 14 (e.g., without zoom or 1× zoom), for imaging of the scene 14 with less zoom than is illustrated, or for wide angle imaging, the sensor 12 may be brought closer to the reflecting device 22.

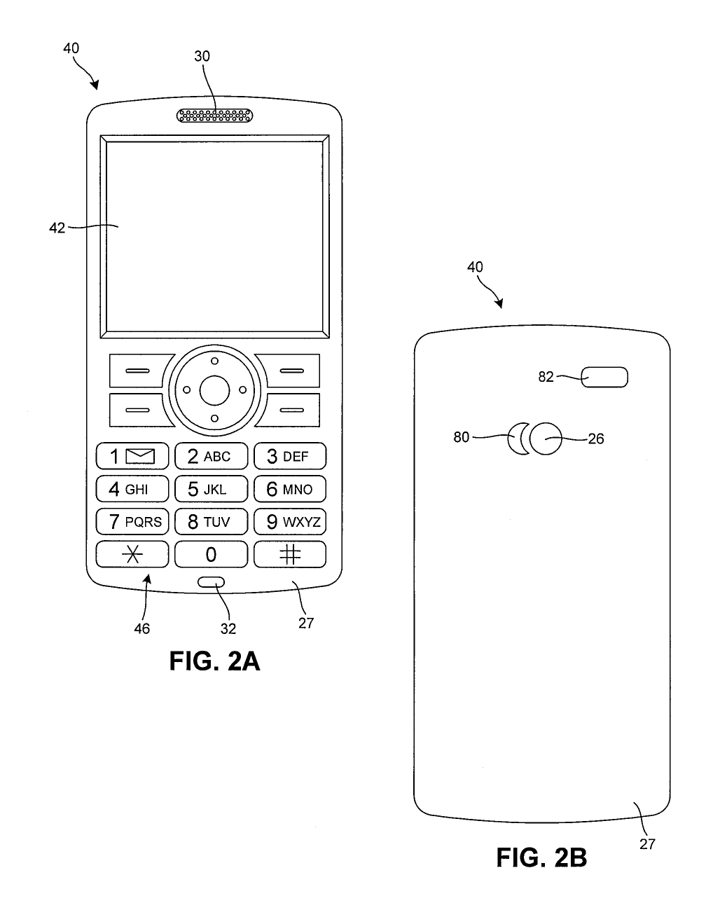

With additional reference to FIGS. 2A and 2B, an electronic device that includes a camera assembly, such as the camera assembly 10, is illustrated. The electronic device of the illustrated embodiment is a mobile telephone and will be referred to as mobile telephone 40. The mobile telephone 40 is shown as having a “brick” or “block” form factor, but it will be appreciated that other form factor types may be utilized, such as a “flip-open” form factor (e.g., a “clamshell”) or a slide-type form factor (e.g., a “slider”). A housing of the mobile telephone 40 may be considered the camera body 27 with respect to which the reflecting device 22 may move. Therefore, the housing will be referred to as housing 27.

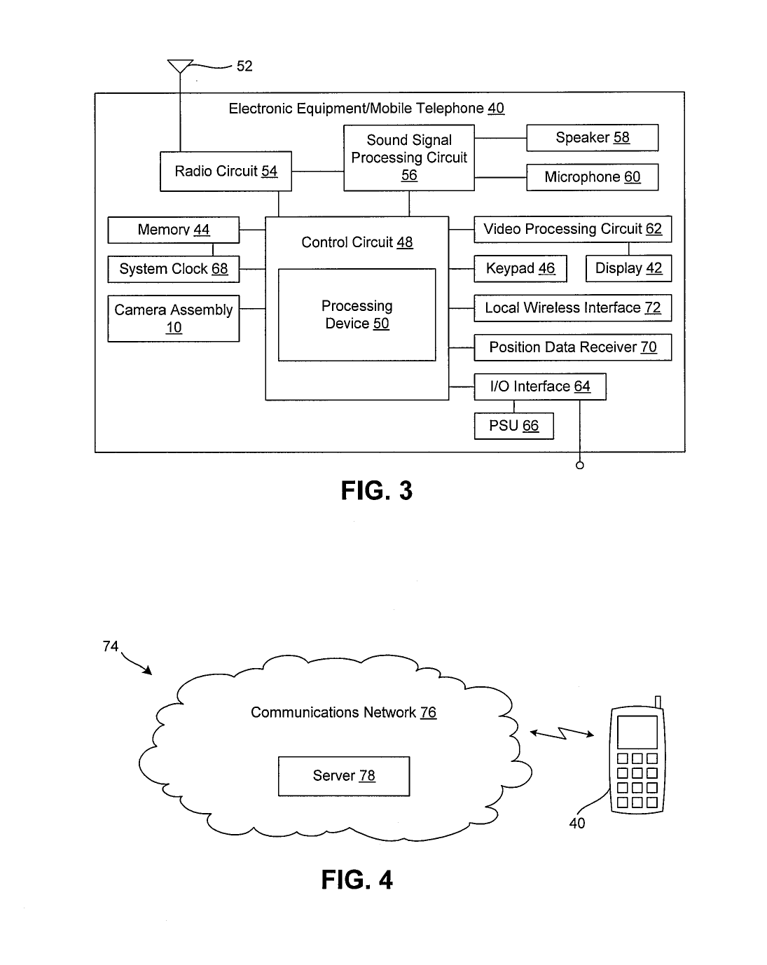

The mobile telephone 40 may include a display 42. The display 42 displays information to a user such as operating state, time, telephone numbers, contact information, various navigational menus, etc., which enable the user to utilize the various features of the mobile telephone 40. The display 42 also may be used to visually display content received by the mobile telephone 40 and/or retrieved from a memory 44 (FIG. 3) of the mobile telephone 40. The display 42 may be used to present images, video and other graphics to the user, such as photographs, mobile television content and video associated with games. Also, the display 42 may be used as an electronic viewfinder for the camera assembly 10.

A keypad 46 provides for a variety of user input operations. For example, the keypad 46 typically includes alphanumeric keys for allowing entry of alphanumeric information such as telephone numbers, phone lists, contact information, notes, etc. In addition, the keypad 46 typically includes special function keys such as a “call send” key for initiating or answering a call, and a “call end” key for ending or “hanging up” a call. Special function keys also may include menu navigation and select keys to facilitate navigating through a menu displayed on the display 42. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 42. Also, the display 42 and keypad 46 may be used in conjunction with one another to implement soft key functionality. The keypad 46 may be used to control the camera assembly 10.

The mobile telephone 40 includes call circuitry that enables the mobile telephone 40 to establish a call and/or exchange signals with a called/calling device, typically another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The mobile telephone 40 may be configured to transmit, receive and/or process data, such as text messages, instant messages, electronic mail messages, multimedia messages, image files, video files, audio files, ring tones, streaming audio, streaming video, data feeds (including podcasts and really simple syndication (RSS) data feeds) and so forth. It is noted that a text message is commonly referred to by some as “an SMS,” which stands for simple message service. SMS is a typical standard for exchanging text messages. Similarly, a multimedia message is commonly referred to by some as “an MMS,” which stands for multimedia message service. MMS is a typical standard for exchanging multimedia messages. Processing such data may include storing the data in the memory 44, executing applications to allow user interaction with the data, displaying video and/or image content associated with the data, outputting audio sounds associated with the data and so forth.

FIG. 3 represents a functional block diagram of the mobile telephone 40. For the sake of brevity, generally conventional features of the mobile telephone 40 will not be described in great detail herein. The mobile telephone 40 includes a primary control circuit 48 that is configured to carry out overall control of the functions and operations of the mobile telephone 40. The control circuit 48 may include a processing device 50, such as a CPU, microcontroller or microprocessor. The processing device 50 executes code stored in a memory (not shown) within the control circuit and/or in a separate memory, such as the memory 44, in order to carry out operation of the mobile telephone 40. Among other tasks, the control circuit 48 may carry out timing functions, such as timing the durations of calls, generating the content of time and date stamps, and so forth. In addition, the processing device 50 may execute code that implements the zoom functions described herein or such functions may be carried out within the camera assembly 10 as described above.

The memory 44 may be, for example, one or more of a buffer, a flash memory, a hard drive, a removable media, a volatile memory, a non-volatile memory, a random access memory (RAM), or other suitable device. In a typical arrangement, the memory 44 may include a non-volatile memory (e.g., a NAND or NOR architecture flash memory) for long term data storage and a volatile memory that functions a system memory for the control circuit 48. The volatile memory may be a RAM implemented with synchronous dynamic random access memory (SDRAM). The memory 44 may exchange data with the control circuit 46 over a data bus. Accompanying control lines and an address bus between the memory 44 and the control circuit 48 also may be present.

For purposes of integrating the camera assembly 10 into the mobile telephone 40, the memory 44 may supplement or stand in place of the memory 30 shown in the embodiment of FIGS. 1A and 1B. Thus, image files and/or video files corresponding to the pictures and/or movies captured with the camera assembly 10 may be stored using the memory 44. Also, the control circuit 46 may supplement or stand in place of the controller 28. In one embodiment, both the control circuit 46 and the controller 28 are present and coordinate activities of the camera assembly 10 based on operational state of the rest of the mobile telephone 10.

Continuing to refer to FIGS. 2A, 2B and 3, the mobile telephone 40 may include an antenna 52 coupled to a radio circuit 54. The radio circuit 54 includes a radio frequency transmitter and receiver for transmitting and receiving signals via the antenna 52 as is conventional. The radio circuit 54 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, WiFi, WiMax, DVB-H, ISDB-T, etc., as well as advanced versions of these standards.

The mobile telephone 40 further includes a sound signal processing circuit 56 for processing audio signals transmitted by and received from the radio circuit 54. Coupled to the sound processing circuit 56 are a speaker 58 and a microphone 60 that enable a user to listen and speak via the mobile telephone 40 as is conventional. The radio circuit 54 and sound processing circuit 56 are each coupled to the control circuit 48 so as to carry out overall operation. Audio data may be passed from the control circuit 48 to the sound signal processing circuit 56 for playback to the user. The audio data may include, for example, audio data from an audio file stored by the memory 44 and retrieved by the control circuit 48, or received audio data such as in the form of streaming audio data from a mobile radio service. The sound processing circuit 56 may include any appropriate buffers, decoders, amplifiers and so forth.

The display 42 may be coupled to the control circuit 48 by a video processing circuit 62 that converts video data to a video signal used to drive the display 42. The video processing circuit 62 may include any appropriate buffers, decoders, video data processors and so forth. The video data may be generated by the control circuit 48, retrieved from a video file that is stored in the memory 44, derived from an incoming video data stream that is received by the radio circuit 54 or obtained by any other suitable method.

The mobile telephone 40 may further include one or more I/O interface(s) 64. The I/O interface(s) 64 may be in the form of typical mobile telephone I/O interfaces and may include one or more electrical connectors. As is typical, the I/O interface(s) 64 may be used to couple the mobile telephone 40 to a battery charger to charge a battery of a power supply unit (PSU) 66 within the mobile telephone 40. In addition, or in the alternative, the I/O interface(s) 64 may serve to connect the mobile telephone 40 to a headset assembly (e.g., a personal handsfree (PHF) device) that has a wired interface with the mobile telephone 40. Further, the I/O interface(s) 64 may serve to connect the mobile telephone 40 to a personal computer or other device via a data cable for the exchange of data. The mobile telephone 40 may receive operating power via the I/O interface(s) 64 when connected to a vehicle power adapter or an electricity outlet power adapter.

The mobile telephone 40 also may include a system clock 68 for clocking the various components of the mobile telephone 40, such as the control circuit 48 and the memory 44.

The mobile telephone 40 also may include a position data receiver 70, such as a global positioning system (GPS) receiver, Galileo satellite system receiver or the like. The position data receiver 70 may be involved in determining the location of the mobile telephone 40.

The mobile telephone 40 also may include a local wireless interface 72, such as an infrared transceiver and/or an RF interface (e.g., a Bluetooth interface), for establishing communication with an accessory, another mobile radio terminal, a computer or another device. For example, the local wireless interface 72 may operatively couple the mobile telephone 40 to a headset assembly (e.g., a PHF device) in an embodiment where the headset assembly has a corresponding wireless interface.

With additional reference to FIG. 4, the mobile telephone 40 may be configured to operate as part of a communications system 74. The system 74 may include a communications network 76 having a server 78 (or servers) for managing calls placed by and destined to the mobile telephone 40, transmitting data to the mobile telephone 40 and carrying out any other support functions. The server 78 communicates with the mobile telephone 40 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 50 may support the communications activity of multiple mobile telephones 10 and other types of end user devices. As will be appreciated, the server 78 may be configured as a typical computer system used to carry out server functions and may include a processor configured to execute software containing logical instructions that embody the functions of the server 78 and a memory to store such software.

Returning to a description of the zoom functionality of the camera assembly 10, it will be appreciated that the zoom functionality may be implemented in a dedicated camera device in accordance with the camera assembly 10 or a device that includes the camera assembly 10 (e.g., the mobile telephone 40). Camera-related components of the camera assembly 10 that are not shown in FIGS. 1A and 1B may include, but are not limited to, an optical view finder, an electronic view finder, a light meter, a flash, user input devices (e.g., buttons, dials, switches, etc.) and a power supply (e.g., inclusive of one or more batteries). A light meter 80 and a flash 82 are illustrated in connection with FIG. 2B.

The camera assembly 10 may be used to establish an image of the scene 14 that is a magnified view of the scene using the zoom feature of the camera assembly 10 and also contains a greater portion of the scene 14 than just the field of view of the camera assembly 10 at the zoom setting (e.g., 2× zoom, 3× zoom, or other zoom setting). Such an image may be referred to by some persons as a “full zoom” image to describe the wider field of view contained in the image than would normally be achievable at the zoom setting for a single exposure. One or ordinary skill in the art will appreciate that the zoom functionality described herein may be applied to the establishment of an image taken without zoom (e.g., a 1× zoom setting) or an image taken with a wide angle setting.

Additional reference will be made to FIGS. 5A to 5C, which illustrate the results of zoom operation of the camera assembly 10. As previously indicated, a series of exposures of the scene are made and, for each of those exposures, the reflecting device 22 is respectively positioned such that the corresponding images 36 each contain a different portion of the scene 14. The exposures and the relative movement of the reflecting device 22 may be made in response to a single user input, such as the depression of a shutter button 84 (FIGS. 1A and 1B). The capturing of images in this manner may be associated with an operational mode of the camera assembly 10 that is turned on or off by the user.

Also, the exposures and the relative movement of the reflecting device 22 may be made at rate that minimizes the effects that movement of the camera assembly 10 by the user or the effects that movement of objects in the scene 14 would have on generating a seamless image of the scene 14 from the individual images 36. In embodiment, the individual images 36 are generated at a rate of about thirty images (or frames) per second to about sixty images per second.

As shown by example in FIG. 5B, after the individual images 36 that correspond to various portions of the scene 14 are captured, the images 36 may be stitched together to form a stitched image 86 of the scene 14. Image stitching software conventionally used to create a panoramic view from multiple exposures that are manually taken by a user may be used in stitching the individual images 36 together to form the stitched image 86. As will be appreciated, the portion of the scene 14 represented in the stitched image 86 will tend to be larger that the portion of the scene 14 represented in any one of the individual images 36. The stitched image 86 may be stored by the memory 30 or 44 in an image file (e.g., a JPEG file) for subsequent retrieval and use as one would make with any other image file. Following storage of the stitched image 86, the camera assembly 10 or electronic device (e.g., the mobile telephone 40) may continue to store any files corresponding to the individual images 36 or may delete these files.

The stitching of the images 36 into the stitched image 86 may include the use of an external data input. For example, the motion of the camera assembly 10 (if any) during exposure of the images 36 may be tracked using the accelerometer 32. The sensed movement may be used to assist in aligning the content of adjacent images 36 during stitching of the images 36 by providing an indication of relative displacement of the corresponding portions of the scene 14 that are contained in the images 36 that may be different than predictable displacement based on known movement of the mirror 22.

In one embodiment, the user may be provided with an option (e.g., through menu selections) to select the relative size and/or shape of the stitched image 86. For instance, the number and relative location of the individual images 36 may be controlled to establish a relatively wide (e.g., long) stitched image 86, a relatively tall stitched image 86, a rectangular stitched image 86, a circular or oval stitch image 86 akin to an image taken with a fish-eye lens but with less distortion of the perspective, and so forth. Settings to select the relative size and/or shape of the stitched image 86 may be adjusted prior to capturing of the individual image 36 or after capturing of the individual images 36 provided that the controller 28 commands the capturing of sufficient images 36 to establish the desired stitched image 86 size and shape.

Another mechanism to allow user selection of the relative size and/or shape of the stitched image 86 is allow user selection of a portion of the stitched image 86. In one embodiment, a window 88 may be overlaid on a displayed version of the stitched image 86. The window 88 may be of any shape (e.g., square, rectangular, circular, oval, hexagon, etc.) and may be changed in size by the user. The window 88 may be panned over the stitched image and resized (e.g., as indicated by arrows 90) to select a portion of the stitched image 86. Once a user selected portion of the stitched image 86 is selected, the portion of the outside the window 88 may be deleted similar to the way an image may be cropped. A windowed image 92 that results from this process is illustrated for exemplary purposes in FIG. 5C.

In the foregoing embodiments, the images 36 are captured on a “frame-by-frame” basis by imaging an entire frame with the sensor 12, moving the reflecting device 22 to the next position, taking another complete frame and so forth. In another embodiment, imaging may be made on a “line-by-line” basis. For instance, a line of the sensor 12 may be imaged with the reflecting device 22 in a first position corresponding to a first portion of the scene 14. Then, the reflecting device 22 may be moved to a second position correspond to a second portion of the scene 14 and the same line (or a different line) may be imaged. The process may repeat until all reflecting device 22 positions relative to the scene 14 are imaged for the line. Thereafter, the reflecting device 22 may be moved to the first position and a second line may be imaged and the reflecting device 22 may be moved to the second position for imaging with the second line. The process may continue until all lines have been imaged for each position. The resulting data set may be combined to form the stitched image 86.

The line-by-line imaging may involve more rapid movement of the reflecting device 22 than is employed for frame-by-frame imaging. In the line-by-line embodiment, a piezoelectric actuator may be used as part of the driver 34 to impart a relatively high frequency motion to the reflecting device 22. A motor and/or other device may be used in other embodiments.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A method of imaging a scene with a camera assembly, comprising:
imaging a first portion of the scene to generate a first image corresponding to a field of view of the camera assembly when a component of the camera assembly that is in an optical pathway of the camera assembly is in a first position with respect to a housing of the camera assembly;
moving the component to a second position with respect to the housing to change the field of view of the camera assembly and imaging a second portion of the scene to generate a second image; and
stitching the first and second images together to generate a stitched image that corresponds to a region of the scene that is larger than each of the first portion of the scene and the second portion of the scene.

2. The method of claim 1, wherein during imaging of the first and second portions of the scene, the camera assembly is placed in a zoomed configuration so that each image is a magnified representation of the scene.

3. The method of claim 1, wherein imaging of the first and second portions of the scene and moving of the component are carried out in response to a single depression of a shutter button by a user of the camera assembly.

4. The method of claim 1, wherein the first image and the second image contain an overlapping portion of the scene.

5. The method of claim 1, wherein the camera assembly includes:
a sensor arranged in a plane transverse to an optical axis of the field of view of the camera assembly; and
a reflecting device to redirect light from the scene toward the sensor, the reflecting device being the component that is moved.

6. The method of claim 5, wherein the reflecting device is a mirror.

7. The method of claim 5, wherein the reflecting device is a prism.

8. The method of claim 5, wherein the reflecting device is moved about one or more axes.

9. The method of claim 1, further comprising imaging additional portions of the scene and each image corresponding to a different field of the view of the camera assembly that is achieved by movement of the component, and the stitching includes stitching each image together.

10. The method of claim 9, wherein the images are arranged in one row or one column.

11. The method of claim 9, wherein the images are arranged in more than one row or more than one column.

12. The method of claim 1, further comprising windowing the stitched image and cropping a portion of the stitched image falling outside the window.

13. The method of claim 1, wherein the camera assembly is part of a mobile telephone.

14. A camera assembly, comprising:
a sensor arranged in a plane transverse to an optical axis of the field of view of the camera assembly;
a reflecting device to redirect light from the scene toward the sensor; and
a driver to move the reflecting device between a first imaging of the scene to generate a first image corresponding to a first field of view of the camera assembly when the reflecting device is in a first position and a second imaging of the scene to generate a second image corresponding to a second field of view of the camera assembly when the reflecting device is in a second position.

15. The camera assembly of claim 14, further comprising a controller that stitches the first and second images together to generate a stitched image that corresponds to a region of the scene that is larger than each of a first portion of the scene represented in the first image and a second portion of the scene represented in the second image.

16. The camera assembly of claim 14, wherein the reflecting device is a mirror or a prism.

17. The camera assembly of claim 14, wherein the reflecting device is moveable about one or more axes.

18. The camera assembly of claim 14, wherein during imaging of the first and second images, the camera assembly is placed in a zoomed configuration so that each image is a magnified representation of the scene.

19. The camera assembly of claim 14, wherein imaging of the first and second portions of the scene and moving of the component are carried out in response to a single depression of a shutter button by a user of the camera assembly.

20. The camera assembly of claim 14, wherein the camera assembly is part of a mobile telephone.
